(19) United States
(12) Patent Application Publication
(10) Pub. No.: US 2017/0357347 A1
(43) Pub. Date: Dec. 14, 2017

(54) TOUCH SENSITIVE PROJECTION SCREEN

(71) Applicant: 3M INNOVATIVE PROPERTIES COMPANY, St. Paul, MN (US)

(72) Inventors: Steven T. Swartz, Pepperell, MA (US); Hui Luo, Woodbury, MN (US); Neeraj Sharma, Woodbury, MN (US); Robert A. Yapel, Oakdale, MN (US); Ronald L. Imken, Georgetown, TX (US); Jung-Sheng Wu, Woodbury, MN (US); David T. Yust, Woodbury, MN (US); Richard J. Pokorny, Maplewood, MN (US); Lan H. Liu, Rosemount, MN (US); Craig R. Sykora, New Richmond, WI (US); David J. McDaniel, Lino Lakes, MN (US); Yu Yang, Eden Prairie, MN (US); Mitchell A.F. Johnson, Maplewood, MN (US)

(21) Appl. No.: 15/523,951

(22) PCT Filed: Oct. 23, 2015
(86) PCT No.: PCT/US2015/057082

§ 371 Date: May 3, 2017

Related U.S. Application Data
(60) Provisional application No. 62/076,964, filed on Nov. 7, 2014.

(51) Int. Cl. G06F 3/044

(52) U.S. Cl. CPC G06F 3/044; G06F 2203/04102; G06F 2203/04103

(57) ABSTRACT

Touch sensitive projection screens are disclosed. In particular, touch sensitive projection screen including drive electrodes, sense electrodes, and optical diffusers are disclosed. The touch sensitive projection screens are adapted for use on a horizontal surface. Touch sensitive projection screens including shrinkable layers are also disclosed.

### BACKGROUND

Projection screens are particularly adapted to received projected light and provide an acceptable viewing surface for the projected images and information. Touch sensitive surfaces use electrical or optical systems to detect the proximity or presence of an input device or devices, such as a stylus or a finger.

### SUMMARY

In one aspect, the present disclosure relates to a touch sensitive projection screen adapted for use on a horizontal surface and having a touch sensitive display region surrounded by a border region. The projection screen includes an anti-slip film adapted to prevent the projection screen from sliding when the projection screen is placed on a horizontal surface, and a touch sensitive film disposed on the anti-slip film. The touch sensitive film includes a driving layer including a plurality of spaced apart opaque drive electrodes disposed along a first direction in the touch sensitive display region, and a plurality of first conductive traces disposed in the border region and routing the drive electrodes to a first terminal area in the border region formed on a first support layer, a sensing layer including a plurality of spaced apart opaque sense electrodes disposed along a second direction perpendicular to the first direction, in the touch sensitive display region, and a plurality of second conductive traces disposed in the border region and routing the sense electrodes to a second terminal area in the border region formed on a second support layer. A first optical diffuser layer is disposed on the touch sensitive film and includes a plurality of particles dispersed therein, a second optical diffuser layer is disposed on and spaced apart from the first optical diffuser layer and includes a plurality of particles dispersed therein, each of the first and second optical diffuser layers diffusely reflect at least 90% of light incident on the diffuser layer, and a third optical diffuser layer is disposed on the second optical diffuser layer and has a structured surface facing away from the second optical diffuser layer. The border region has an outermost perimeter and an innermost perimeter coincident with an outermost perimeter of the touch sensitive display region, and the border region defines a first opening exposing the first terminal area and a corresponding portion of the first support layer and a second opening exposing the second terminal area and a corresponding portion of the second support layer.

In some embodiments, the touch sensitive projection screen is a front projection screen. In some embodiments, the anti-slip film includes rubber. In some embodiments, the anti-slip film includes a bottom structured surface such that when the projection screen is placed on a horizontal surface, the structured surface contacts the horizontal surface. In some embodiments, the touch sensitive projection screen further includes a first layer adhered to the anti-slip film via an adhesive and a second layer adhered to the first layer via an adhesive, the first and second layers preventing the projection screen from curling. The first and second layers may include PET. In some embodiments, the plurality of spaced apart opaque drive electrodes and the plurality of first conductive traces are formed on the first support layer, and the plurality of spaced apart opaque sense electrodes and the plurality of second conductive traces are formed on the second support layer. In some embodiments, each of the first and second support layers includes PET. In some embodiments, the driving layer is adhered to the sensing layer via an adhesive. In some embodiments, each of the first and second optical diffusers appears white when illuminated with white light. In some embodiments, the plurality of particles dispersed in the first and second optical diffuser layers include TiO₂ or BaSO₄. In some embodiments, each of the first and second optical diffuser layers include PET or polycarbonate. In some embodiments, the second optical diffuser layer is thinner than the first optical diffuser layer. In some embodiments, the second optical diffuser layer is adhered to the first optical diffuser layer via an adhesive. In some embodiments, each of the first and second optical diffuser layers diffusely reflects at least 95% of light incident on the diffuser layer. In some embodiments, the third optical diffuser layer absorbs at least 40% of light in a range from 800 to 1400 nm and transmits at least 80% of light in a range from 400 to 650 nm. In some embodiments, the touch sensitive projection screen includes a plurality of first particles having a first composition and a first average size, and a plurality of second particles having a different second composition and a second average size, and the second average size is at least 2 times greater than the first average size. In some embodiments, the first composition includes TiO₂. In some embodiments, the second composition includes one or more of PMMA or silica. In some embodiments, the first average size is less than 600 nm and the second average size is greater than 1 micron. In some embodiments, the third optical diffuser layer has an average thickness of at least 2 microns. In some embodiments, the third optical diffuser layer is formed directly on the second optical diffuser layer. In some embodiments, each of the first and second openings is spaced apart from the outermost perimeter of the border region. In some embodiments, each of the first and second openings is spaced apart from the innermost perimeter of the border region. In some embodiments, the first opening is adjacent the second opening. In some embodiments, the touch sensitive projection screen further includes a first flexible printed circuit disposed in the first opening and making electrical contact with the first conductive traces in the first terminal area, the first flexible printed circuit adhering to the corresponding portion of the first support layer exposed in the first opening, and a second flexible printed circuit disposed in the second opening and making electrical contact with the second conductive traces in the second terminal area, the second flexible printed circuit adhesive to the corresponding portion of the second support layer exposed in the second opening. In some embodiments, the touch sensitive projection screen is substantially flexible.

In another aspect, the present disclosure relates to a touch sensitive projection screen adapted for use on a horizontal surface and having a touch sensitive display region surrounded by a border region. The projection screen includes a touch sensitive film which includes a plurality of spaced apart opaque drive electrodes disposed along a first direction in the touch sensitive display region and a plurality of first conductive traces disposed in the border region and routing the drive electrodes to a first terminal area in the border region, the drive electrodes and the first conductive traces and the first terminal area formed on a first shrinkable support layer, a plurality of spaced apart opaque sense electrodes disposed along a second direction, perpendicular to the first direction, in the touch sensitive display region, and a plurality of second conductive traces disposed in the border region and routing the sense electrodes to a second terminal area in the border region, the sense electrodes and the second conductive traces and the second terminal area formed on a second shrinkable support layer, a first optical diffuser shrinkable layer disposed on the touch sensitive film and including a plurality of particles dispersed therein, and a second optical diffuser shrinkable layer disposed on and spaced apart from the first optical diffuser layer and including a plurality of particles dispersed therein, each of the first and second optical diffuser layers diffusely reflecting at least 90% of light incident on the diffuser layer. The first and second shrinkable support layers and the first and second optical diffuser shrinkable layers are preshrunk at a temperature greater than a highest operating temperature of the projection screen.

In some embodiments, the projection screen further includes a third optical diffuser layer disposed on the second optical diffuser shrinkable layer and having a structured surface facing away from the second optical diffuser layer. In some embodiments, the projection screen further includes an anti-slip film adapted to prevent the projection screen from sliding when the projection screen is placed on a horizontal surface. In some embodiments, the projection screen further includes a first layer adhered to the anti-slip film via an adhesive and a second layer adhered to the first layer via an adhesive, the first and second layers preventing the projection screen from curling. In some embodiments, the first and second shrinkable support layers include PET. In some embodiments, the first and second optical diffuser shrinkable layers include PET. In some embodiments, the first and second shrinkable support layers and the first and second optical diffuser shrinkable layers include PET.

In yet another aspect, the present disclosure relates to a touch sensitive system having a touch sensitive region surrounded by a border region. The touch sensitive system includes a plurality of spaced apart drive electrodes disposed along a first direction in the touch sensitive region and a plurality of first conductive opaque traces disposed in the border region and routing the drive electrodes to a first terminal area in the border region, the drive electrodes and the first conductive opaque traces and the first terminal area formed on a first support layer more shrinkable along a first in-plane direction than along an orthogonal second in-plane direction, a plurality of spaced apart sense electrodes disposed along a second direction, orthogonal to the first direction, in the touch sensitive region, and a plurality of second conductive opaque traces disposed in the border region and routing the drive electrodes to a second terminal area in the border region, the sense electrodes and the second conductive opaque traces and the second terminal area formed on a second support layer more shrinkable along the second in-plane direction than along the first in-plane direction, and a plurality of nodes, each node defined by corresponding drive and sense electrodes traversing each other at the node, the touch sensitive system configured to detect a location of a touch applied proximate a node by detecting a change in a coupling capacitance between the corresponding drive and sense electrodes traversing each other at the node.

In some embodiments, the first support layer and the second support layer include PET. In some embodiments, the first support layer and the second support layer are preshrunk at a temperature greater than a highest operating temperature of the touch sensitive system. In some embodiments, the touch sensitive system further includes an anti-slip film adapted to prevent the projection screen from sliding when the touch sensitive system is placed on a horizontal surface.

### BRIEF DESCRIPTION OF THE DRAWINGS

FIG. 1 is an elevation cross-section of a touch sensitive projection screen.

FIG. 2 is an elevation cross-section of another portion of the touch sensitive projection screen

FIG. 3 is a top plan view of the touch sensitive projection screen.

### DETAILED DESCRIPTION

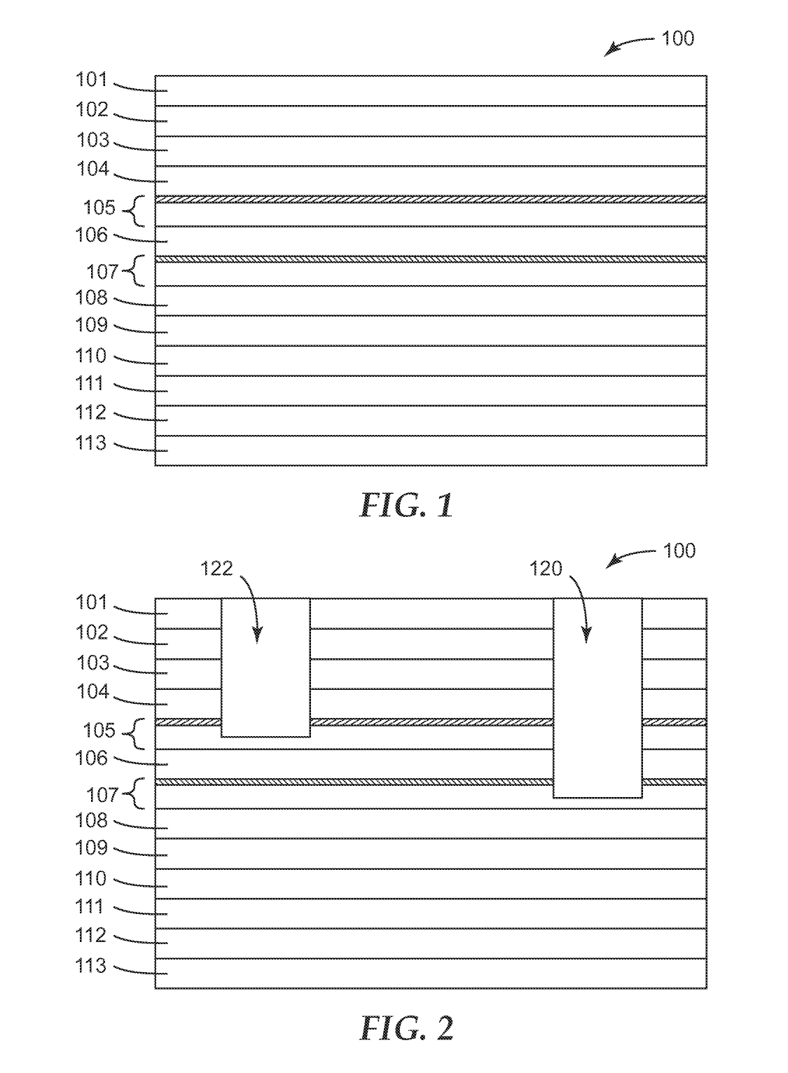

FIG. 1 is an elevation cross-section of a touch sensitive projection screen. Touch sensitive projection screen 100 includes anti-slip film 113, first touch sensor 107, second touch sensor 105, first optical diffuser layer 103, second optical diffuser layer 101, first stabilizing layer 111 and second stabilizing layer 109, and adhesive layers 102, 104, 106, 108, 110, and 112.

Overall, touch sensitive projection screen 100 can be any suitable size and shape. Generally, touch sensitive projection screen 100 will be substantially flat, with any suitable thickness. In some embodiments, the touch sensitive projection screen may be designed to provide a suitable desktop workspace. In some embodiments, the touch sensitive projection screen may be configured to rest flatly on a horizontal surface to, for example, provide a reasonable writing or drawing surface. In some embodiments, touch sensitive projection screen 100 is substantially square or rectangular (with or without rounded corners or other curved aesthetic features). Weight and portability may also be considerations in determining the appropriate dimensions for touch sensitive projection screen 100. FIG. 1, for ease of illustration, depicts touch sensitive projection screen 100 about as thick as is wide, although in many cases touch sensitive projection screen 100 will be much less thick as it is wide and long. For example, touch sensitive projection screen 100 may be between 1 and 3 mm thick. Touch sensitive projection screen 100 may be substantially flexible, meaning it can be rolled or folded within normal use without damaging or permanently deforming the screen or its components. Note that a sharp crease or extreme bending may damage the screen, and it still may be considered to be substantially flexible.

Second optical diffuser layer 101 is disposed on first optical diffuser layer 103 and attached via adhesive layer 102. Either or both of the first and second optical diffuser layers may be a polymeric substrate including a plurality of particles. Depending on the application, these particles may have an appropriate size and loading in order to provide a diffusive effect. The particles may be spherical, as in beads, or they may have any other regular or irregular shape or shape distribution. The particles, in some cases, may include TiO₂ or BaSO₄ particles. In some embodiments, the particles may include poly(methyl methacrylate) (PMMA) or silica beads. In some embodiments, the first and second optical diffuser layers may scatter light as to appear white when illuminated with white or substantially white light. In some embodiments, the first and second optical diffuser layers may include or be primarily made of polyethylene terephthalate (PET). In some embodiments, the first and second optical diffuser layers may include or be primary made of polycarbonate. The first and second optical diffuser layers may be selected to be made with a shrinkable material, making them first and second optical diffuser shrinkable layers. In some embodiments, the first and second optical diffuser shrinkable layers are preshrunk at a high temperature, for example at a temperature higher than the normal operating temperature of the touch sensitive projection screen. In some embodiments, each of first optical diffuser layer 103 and second optical diffuser layer 101 diffusely reflects at least 90% of light incident on the corresponding layer. Sometimes, each of the layers diffusely reflects at least 95% of light incident on that layer. In some embodiments, second optical diffuser layer 101 is thinner than first optical diffuser layer 103.

Adhesive layer 102 may be any suitable adhesive (as with all of the adhesive layers described herein, although they may be the same or different). In some embodiments, the adhesive is an optically clear adhesive (OCA). In some embodiments, adhesive 102 is a pressure sensitive adhesive (PSA). Pressure sensitive adhesives, particularly pressure sensitive adhesives that adhere without requiring curing, for example, UV curing, may be useful to maintain good contact and preserve flexibility in the finished touch sensitive projection screen without cracking or delaminating. The thickness of the pressure sensitive adhesive may depend on the desired adhesion strength. In some embodiments, the thickness of the pressure sensitive adhesive may be important to space apart the optical diffuser layers. The spacing of the optical diffuser layers may be useful to reduce visibility of components underneath the optical diffuser layers. In some embodiments, the spacing of the optical diffuser layers may increase the effective haze or may decrease the effective clarity of the combination of the diffuser layers.

In some embodiments, second optical diffuser layer 101 may further include a hardcoat or structured layer (not shown for ease of illustration) formed directly on second optical diffuser layer 101. In some embodiments the structured layer faces away from second optical diffuser layer 101. The structured layer may include prisms, bumps, beads, or other regular, semiregular, or irregular features. In some embodiments, the structured surface may include a matte or similar surface. The hardcoat or structured layer may provide structural stability and damage protection from handling and regular use. In some embodiments, the layer may be absorbing for infrared or at least near infrared light. These layers may include near infrared absorbing materials such as transparent conductive oxide nanoparticles (antimony- or tin-doped indium oxide, or doped zinc oxides), plasmonic nanoparticles (e.g., gold and silver), organic and metal organic dyes, and transition metal and lanthanide ion based materials. In some embodiments, the layer may absorb some portion of light in a wavelength range from 800 nm to 1400 nm, such as at least 40% or 50, and may absorb some portion of light at a wavelength range between 400 and 650 nm, such as 80% or 90%. The hardcoat or structured layer may be formed from any suitable process, including a cast-and-cure method. In some embodiments, a hardcoat is formed by splitting a coating between a substrate and a smooth roll and, optionally, subsequently curing the coating. Such a process is described in U.S. Pat. No. 8,623,140 (Yapel et al.), incorporated herein by reference. Depending on the application, the hardcoat or surface may provide a lower coefficient of friction, a paper-like tactile sensation for writing, scratch or abrasion resistance, or other properties. In some embodiments, the layer may be formed separately and laminated or attached to second optical diffuser layer 101. In some embodiments, the layer may be considered the third optical diffuser layer, and may have a thickness of at least 2 microns, on average. In some embodiments, one of the optical diffuser layers includes particles including a first group with a first average size and a second group with a second average size, where the second average size is at least twice the first average size. The particles may have a first group with an average size of less than 600 nm and a second group with a second average size of greater than 1 micron. The first group may include, for example, TiO₂, and the second group may include, for example, PMMA or silica.

Adhesive layer 104 attaches first optical diffuser layer 103 to second touch sensor 105 and the touch sensitive portion of the touch sensitive projection screen. Second touch sensor 105 is attached to first touch sensor 107 via adhesive layer 106. First touch sensor 107 and second touch sensor 105 may be formed of substantially the same materials, or they may be different. In general, embodiments of the touch sensitive projection screen are projected capacitance systems. In some embodiments, each of the first and second touch sensors includes conductive electrodes provided on a substrate or support layer, spaced apart, and oriented substantially orthogonally to each other, creating a conductive grid. The conductive electrodes may be formed from any suitable material, including indium tin oxide (ITO), thinly patterned copper, or silver nanowires. The orthogonally oriented conductive electrodes may be referred to as X and Y electrodes, or as row and column electrodes. The appropriate material for the conductive electrodes may be selected based on a number of factors, including pattern visibility, sheet resistance of the overall touch sensor, ease of manufacturing, material cost, and other considerations. In some embodiments, the electrodes may be opaque.

The substrate materials for first touch sensor 107 and second touch sensor 105 may be any suitable material, and may be a polymeric material, such as PET, or an inorganic material such as a glass. In some embodiments, the substrate material may be a shrinkable support layer (shrinkable, for example, with the application of heat). In some embodiments, the shrinkable support layer may be preshrunk, for example, at a high temperature: higher than the highest operating temperature of the projection screen. This may ensure that post-manufacturing, the projection screen does not deform or warp based on heat induced relaxation from normal operating parameters. In some embodiments, each of the substrate materials may be a layer that is shrinkable more in a first in-plane direction than in a second, orthogonal in-plane direction. In some embodiments, the touch sensitive projection screen may be configured such that the first in-plane (more shrinkable) directions of the substrates are aligned orthogonally or substantially orthogonally. In other words, the first support layer may be more shrinkable along the first in-plane direction than along an orthogonal second in-plane direction, while the second support layer may be more shrinkable along the second in-plane direction than along the first in-plane direction.

Suitable electrical components are included: for example, in some embodiments, first touch sensor 107 is provided with a current. Accordingly, first touch sensor would be considered to be a driving layer. Second touch sensor 105, in this case would not be provided with a current, and would be considered a sensing layer. The intersection of these layers (from a plan view) creates a grid of points, intersections, or nodes, where, with appropriate circuitry, the location of one or more touches may be identified by a change in coupling capacitance between the corresponding drive and sensing electrodes that traverse each other at the node or intersection. Additional conductive traces may be provided outside of the touch sensitive area to route the appropriate signals to a processor for interpretation. In some embodiments, these conductive traces route the signals to a first and second terminal area, respectively, where the conductive traces are connected to flexible circuits or conductors to route the signal to a processor not located on or within the touch sensitive projection screen. The conductive traces may be formed from any suitable conductive material; however, a sharp change in material may result in signal reflection and loss. In some embodiments, the processor may be remote and the information may be transmitted via an antenna or other wireless communication component. In some embodiments, the Y electrode may be a sensing layer; in some embodiments, the Y electrode may be a driving layer. Either first touch sensor 107 or second touch sensor 105 may be the X or Y electrode, and similarly may be the driving or sensing electrode or layer. In some embodiments, the conductors may be on both sides of the same layer, eliminating the need for adhesive 106.

First stabilizing layer 111 and second stabilizing layer 109 are adhered or attached to first touch sensor 107 via adhesive layer 108. First stabilizing layer 111 and second stabilizing layer 109 are attached to each other via adhesive layer 110. Each of the first and second stabilizing layers may be any suitable thickness, and they may have the same thicknesses or different thicknesses. In some embodiments, the first and second stabilizing layer are transparent PET or polycarbonate. In some embodiments, the first and second stabilizing layers may include pigment or diffusive particles. In some embodiments, the thickness and materials of the first and second stabilizing layers are selected to provide dimensional stability or stiffness, or warp/curl resistance to the touch sensitive projection screen.

Anti-slip film 113 is attached to first stabilizing layer 111 via adhesive layer 112. Anti-slip film 113 may be any suitable material, and may have any suitable coating, texture, or structure on its bottom surface (i.e., facing away from adhesive layer 112) in order to impart anti-slip properties to touch sensitive projection screen 100. In some embodiments, anti-slip film may be a rubber mat or include rubber. In some embodiments, anti-slip film may include microtextured “fingers” or pips to create a sufficiently high coefficient of friction between the anti-slip film and a surface for typical uses, such as a wood or glass desk surface. Anti-slip film 113 may include an abrasive or magnetic portion. Anti-slip film 113 may include a weak adhesive or a tacky substance. Anti-slip film 113 may have grip areas located in certain portions of anti-slip film 113, such as in the corners or along some or all of the sides. Rubber or polymeric pads may be used on anti-slip film 113. Anti-slip film 113 may be any suitable thickness.

FIG. 2 is an elevation cross-section of another portion of the touch sensitive projection screen. FIG. 2 corresponds to FIG. 1 except FIG. 2 shows first opening 120 and second opening 122. First opening 120 is shown having exemplary dimensions and proportions only, and may be any suitable size and shape. First opening 120 exposes a portion of first touch sensor 107 in the first terminal area. First opening 120 may extend to the support layer of first touch sensor 107, the conductive traces in the terminal area, or portions of both. First opening 120 may be used in some embodiments to insert a flexible printed circuit or other electrical connection mechanism such as a cable and attach the flexible printed circuit to the exposed support layer of first touch sensor 107 and making electrical contact with the conductive traces. If flexible circuits are used, for example, any suitable bonding mechanism may be used, such as an anisotropic conductive adhesive/film, solder, or the like.

Second opening 122 exposes a portion of second touch sensor 105 in the second terminal area. As for first opening 120, second opening 122 may extend to the support or substrate layer of second touch sensor 105, the conductive traces attached to the spaced apart electrodes of second touch sensor 105, or portions of both. Also, second opening 122 may be configured to accept any suitable connector or flexible printed circuit, attaching to the exposed portion of second touch sensor 105 and forming electrical contacts with the conductive traces.

Each of first opening 120 and second opening 122 may be any suitable shape and have any suitable dimensions. For example, although the first and second openings are shown to have parallel, straight sides, this need not be the case, and some or all of the sides may be tapered or curved. This may be for aesthetic purposes or to facilitate a better or more secure bonding or connection to flexible circuits or connectors. In some embodiments, there may be more than two openings.

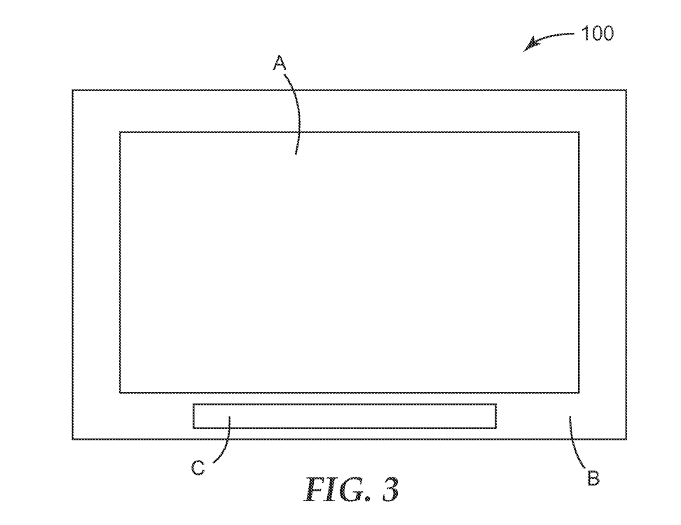

FIG. 3 is a top plan view of the touch sensitive projection screen of FIG. 1. As the overall layout of the touch sensitive projection screen is difficult to ascertain with cross-section views, FIG. 3 provides an overview of an exemplary layout. In this example, area A is a touch sensitive portion or display region of touch sensitive projection screen 100, area B is a border region, and area C is the terminal region where the first and second terminal areas may be located, within the border area. The terminal region may be spaced apart from both the innermost perimeter of the border region and the outermost perimeter of the border region, or in some cases only one of the innermost and outermost perimeters. In some embodiments, the innermost perimeter of the border region may coincide with an outermost perimeter of the touch sensitive portion or display region.

This particular illustrated configuration, however, is not critical and may depend on the application. For example, the touch sensitive portion may be a larger or smaller proportion of the total area of touch sensitive projection screen 100. Likewise, the terminal region may not be continuous and may actually include two discontinuous portions, for each of the first and second terminal areas, for example. These discontinuous portions may be along a same edge or along opposite or adjacent edges.

The following are a list of items of the present disclosure.

Item 1 is a touch sensitive projection screen adapted for use on a horizontal surface and having a touch sensitive display region surrounded by a border region, the projection screen comprising:

an anti-slip film adapted to prevent the projection screen from sliding when the projection screen is placed on a horizontal surface;

a touch sensitive film disposed on the anti-slip film and comprising:

a driving layer comprising a plurality of spaced apart opaque drive electrodes disposed along a first direction in the touch sensitive display region, and a plurality of first conductive traces disposed in the border region and routing the drive electrodes to a first terminal area in the border region formed on a first support layer;

a sensing layer comprising a plurality of spaced apart opaque sense electrodes disposed along a second direction, perpendicular to the first direction, in the touch sensitive display region, and a plurality of second conductive traces disposed in the border region and routing the sense electrodes to a second terminal area in the border region formed on a second support layer;

a first optical diffuser layer disposed on the touch sensitive film and comprising a plurality of particles dispersed therein;

a second optical diffuser layer disposed on and spaced apart from the first optical diffuser layer and comprising a plurality of particles dispersed therein, each of the first and second optical diffuser layers diffusely reflecting at least 90% of light incident on the diffuser layer;

a third optical diffuser layer disposed on the second optical diffuser layer and having a structured surface facing away from the second optical diffuser layer, the border region having an outermost perimeter and an innermost perimeter coincident with an outermost perimeter of the touch sensitive display region, the border region defining a first opening exposing the first terminal area and a corresponding portion of the first support layer and a second opening exposing the second terminal area and a corresponding portion of the second support layer.

Item 2 is the touch sensitive projection screen of claim 1 being a front projection screen.

Item 3 is the touch sensitive projection screen of item 1, wherein the anti-slip film comprises rubber.

Item 4 is the touch sensitive projection screen of item 1, wherein the anti-slip film comprises a bottom structured surface such that when the projection screen is placed on a horizontal surface, the structured surface contacts the horizontal surface.

Item 5 is the touch sensitive projection screen of item 1 further comprising:

a first layer adhered to the anti-slip film via an adhesive; and

a second layer adhered to the first layer via an adhesive, the first and second layers preventing the projection screen from curling.

Item 6 is the touch sensitive projection screen of item 5, wherein each of the first and second layers comprises PET.

Item 7 is the touch sensitive projection screen of item 1, wherein:
the plurality of spaced apart opaque drive electrodes and the plurality of first conductive traces are formed on the first support layer; and
the plurality of spaced apart opaque sense electrodes and the plurality of second conductive traces are formed on the second support layer.

Item 8 is the touch sensitive projection screen of item 7, wherein each of the first and second support layers comprises PET.

Item 9 is the touch sensitive projection screen of item 1, wherein the driving layer is adhered to the sensing layer via an adhesive.

Item 10 is the touch sensitive projection screen of item 1, wherein each of the first and second optical diffusers appears white when illuminated with white light.

Item 11 is the touch sensitive projection screen of item 1, wherein the plurality of particles dispersed in the first and second optical diffuser layers comprise TiO₂ or BaSO₄.

Item 12 is the touch sensitive projection screen of item 1, wherein each of the first and second optical diffusers comprises PET or polycarbonate.

Item 13 is the touch sensitive projection screen of item 1, wherein the second optical diffuser layer is thinner than the first optical diffuser layer.

Item 14 is the touch sensitive projection screen of item 1, wherein the second optical diffuser layer is adhered to the first optical diffuser layer via an adhesive.

Item 15 is the touch sensitive projection screen of item 1, wherein each of the first and second optical diffuser layers diffusely reflects at least 95% of light incident on the diffuser layer.

Item 16 is the touch sensitive projection screen of item 1, wherein the third optical diffuser layer absorbs at least 40% of light in a range from 800 to 1400 nm and transmits at least 80% of light in a range from 400 to 650 nm.

Item 17 is the touch sensitive projection screen of item 1 comprising a plurality of first particles having a first composition and a first average size, and plurality of second particles having a different second composition and a second average size, the second average size being at least 2 times greater than the first average size.

Item 18 is the touch sensitive projection screen of item 17, wherein the first composition comprises TiO₂.

Item 19 is the touch sensitive projection screen of item 17, wherein the second composition comprises one or more of PMMA or silica.

Item 20 is the touch sensitive projection screen of item 17, wherein the first average size is less than 600 nm and the second average size is greater than 1 micron.

Item 21 is the touch sensitive projection screen of item 1, wherein the third optical diffuser layer has an average thickness of at least 2 microns.

Item 22 is the touch sensitive projection screen of item 1, wherein the third optical diffuser layer is formed directly on the second optical diffuser layer.

Item 23 is the touch sensitive projection screen of item 1, wherein each of the first and second openings is spaced apart from the outermost perimeter of the border region.

Item 24 is the touch sensitive projection screen of item 1, wherein each of the first and second openings is spaced apart from the innermost perimeter of the border region.

Item 25 is the touch sensitive projection screen of item 1, wherein the first opening is adjacent the second opening.

Item 26 is the touch sensitive projection screen of item 1 further comprising:

a first flexible printed circuit disposed in the first opening and making electrical contact with the first conductive traces in the first terminal area, the first flexible printed circuit adhering to the corresponding portion of the first support layer exposed in the first opening; and

a second flexible printed circuit disposed in the second opening and making electrical contact with the second conductive traces in the second terminal area, the second flexible printed circuit adhering to the corresponding portion of the second support layer exposed in the second opening.

Item 27 is the touch sensitive projection screen of item 1 being substantially flexible.

Item 28 is a touch sensitive projection screen adapted for use on a horizontal surface and having a touch sensitive display region surrounded by a border region, the projection screen comprising:

a touch sensitive film comprising:

a plurality of spaced apart opaque drive electrodes disposed along a first direction in the touch sensitive display region, and a plurality of first conductive traces disposed in the border region and routing the drive electrodes to a first terminal area in the border region, the drive electrodes and the first conductive traces and the first terminal area formed on a first shrinkable support layer;

a plurality of spaced apart opaque sense electrodes disposed along a second direction, perpendicular to the first direction, in the touch sensitive display region, and a plurality of second conductive traces disposed in the border region and routing the sense electrodes to a second terminal area in the border region, the sense electrodes and the second conductive traces and the second terminal area formed on a second shrinkable support layer;

a first optical diffuser shrinkable layer disposed on the touch sensitive film and comprising a plurality of particles dispersed therein; and

a second optical diffuser shrinkable layer disposed on and spaced apart from the first optical diffuser layer and comprising a plurality of particles dispersed therein, each of the first and second optical diffuser layers diffusely reflecting at least 90% of light incident on the diffuser layer; wherein

the first and second shrinkable support layers and the first and second optical diffuser shrinkable layers are preshrunk at a temperature greater than a highest operating temperature of the projection screen.

Item 29 is the touch sensitive projection screen of item 28, further comprising a third optical diffuser layer disposed on the second optical diffuser shrinkable layer and having a structured surface facing away from the second optical diffuser layer.

Item 30 is the touch sensitive projection screen of item 28, further comprising an anti-slip film adapted to prevent the projection screen from sliding when the projection screen is placed on a horizontal surface.

Item 31 is the touch sensitive projection screen of item 30, further comprising a first layer adhered to the anti-slip film via an adhesive and a second layer adhered to the first layer via an adhesive, the first and second layers preventing the projection screen from curling.

Item 32 is the touch sensitive projection screen of item 28, wherein the first and second shrinkable support layers comprise PET.

Item 33 is the touch sensitive projection screen of item 28, wherein the first and second optical diffuser shrinkable layers comprise PET.

Item 34 is the touch sensitive projection screen of item 28, wherein the first and second shrinkable support layers and the first and second optical diffuser shrinkable layers comprise PET.

Item 35 is a touch sensitive system having a touch sensitive region surrounded by a border region, the touch sensitive system comprising:

a plurality of spaced apart drive electrodes disposed along a first direction in the touch sensitive region, and a plurality of first conductive opaque traces disposed in the border region and routing the drive electrodes to a first terminal area in the border region, the drive electrodes and the first conductive opaque traces and the first terminal area formed on a first support layer more shrinkable along a first in-plane direction than along an orthogonal second in-plane direction;

a plurality of spaced apart sense electrodes disposed along a second direction, orthogonal to the first direction, in the touch sensitive region, and a plurality of second conductive opaque traces disposed in the border region and routing the drive electrodes to a second terminal area in the border region, the sense electrodes and the second conductive opaque traces and the second terminal area formed on a second support layer more shrinkable along the second in-plane direction than along the first in-plane direction; and

a plurality of nodes, each node defined by corresponding drive and sense electrodes traversing each other at the node, the touch sensitive system configured to detect a location of a touch applied proximate a node by detecting a change in a coupling capacitance between the corresponding drive and sense electrodes traversing each other at the node.

Item 36 is the touch sensitive system of item 35, wherein the first support layer and the second support layer comprise PET.

Item 37 is the touch sensitive system of item 35, wherein the first support layer and the second support layer are preshrunk at a temperature greater than a highest operating temperature of the touch sensitive system.

Item 38 is the touch sensitive system of item 35, further comprising an anti-slip film adapted to prevent the touch sensitive system from sliding when the touch sensitive system is placed on a horizontal surface.

Descriptions for elements in figures should be understood to apply equally to corresponding elements in other figures, unless indicated otherwise. The present invention should not be considered limited to the particular embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

1-10. (canceled)

11. A touch sensitive projection screen adapted for use on a horizontal surface and having a touch sensitive display region surrounded by a border region, the projection screen comprising:
an anti-slip film adapted to prevent the projection screen from sliding when the projection screen is placed on a horizontal surface;
a touch sensitive film disposed on the anti-slip film and comprising:
a driving layer comprising a plurality of spaced apart opaque drive electrodes disposed along a first direction in the touch sensitive display region, and a plurality of first conductive traces disposed in the border region and routing the drive electrodes to a first terminal area in the border region formed on a first support layer;
a sensing layer comprising a plurality of spaced apart opaque sense electrodes disposed along a second direction, perpendicular to the first direction, in the touch sensitive display region, and a plurality of second conductive traces disposed in the border region and routing the sense electrodes to a second terminal area in the border region formed on a second support layer;
a first optical diffuser layer disposed on the touch sensitive film and comprising a plurality of particles dispersed therein;
a second optical diffuser layer disposed on and spaced apart from the first optical diffuser layer and comprising a plurality of particles dispersed therein, each of the first and second optical diffuser layers diffusely reflecting at least 90% of light incident on the diffuser layer;
a third optical diffuser layer disposed on the second optical diffuser layer and having a structured surface facing away from the second optical diffuser layer, the border region having an outermost perimeter and an innermost perimeter coincident with an outermost perimeter of the touch sensitive display region, the border region defining a first opening exposing the first terminal area and a corresponding portion of the first support layer and a second opening exposing the second terminal area and a corresponding portion of the second support layer.

12. The touch sensitive projection screen of claim 11 being a front projection screen.

13. The touch sensitive projection screen of claim 11, wherein the anti-slip film comprises rubber.

14. The touch sensitive projection screen of claim 11, wherein the anti-slip film comprises a bottom structured surface such that when the projection screen is placed on a horizontal surface, the structured surface contacts the horizontal surface.

15. The touch sensitive projection screen of claim 11 further comprising:
a first layer adhered to the anti-slip film via an adhesive; and
a second layer adhered to the first layer via an adhesive, the first and second layers preventing the projection screen from curling.

16. The touch sensitive projection screen of claim 15, wherein each of the first and second layers comprises PET.

17. The touch sensitive projection screen of claim 11, wherein:
the plurality of spaced apart opaque drive electrodes and the plurality of first conductive traces are formed on the first support layer; and
the plurality of spaced apart opaque sense electrodes and the plurality of second conductive traces are formed on the second support layer.

18. The touch sensitive projection screen of claim 17, wherein each of the first and second support layers comprises PET.

19. The touch sensitive projection screen of claim 11, wherein the driving layer is adhered to the sensing layer via an adhesive.

20. The touch sensitive projection screen of claim 11, wherein each of the first and second optical diffusers appears white when illuminated with white light.

21. The touch sensitive projection screen of claim 11, wherein the plurality of particles dispersed in the first and second optical diffuser layers comprise TiO₂ or BaSO₄.

22. The touch sensitive projection screen of claim 11, wherein each of the first and second optical diffusers comprises PET or polycarbonate.

23. The touch sensitive projection screen of claim 11, wherein the second optical diffuser layer is thinner than the first optical diffuser layer.

24. The touch sensitive projection screen of claim 11, wherein the second optical diffuser layer is adhered to the first optical diffuser layer via an adhesive.

25. The touch sensitive projection screen of claim 11, wherein each of the first and second optical diffuser layers diffusely reflects at least 95% of light incident on the diffuser layer.

26. The touch sensitive projection screen of claim 11, wherein the third optical diffuser layer absorbs at least 40% of light in a range from 800 to 1400 nm and transmits at least 80% of light in a range from 400 to 650 nm.

27. The touch sensitive projection screen of claim 11 comprising a plurality of first particles having a first composition and a first average size, and plurality of second particles having a different second composition and a second average size, the second average size being at least 2 times greater than the first average size.

28. The touch sensitive projection screen of claim 27, wherein the first composition comprises TiO₂.

29. The touch sensitive projection screen of claim 27, wherein the second composition comprises one or more of PMMA or silica.

30. The touch sensitive projection screen of claim 27, wherein the first average size is less than 600 nm and the second average size is greater than 1 micron.

31. The touch sensitive projection screen of claim 11, wherein the third optical diffuser layer has an average thickness of at least 2 microns.

32. The touch sensitive projection screen of claim 11, wherein the third optical diffuser layer is formed directly on the second optical diffuser layer.

33. The touch sensitive projection screen of claim 11, wherein each of the first and second openings is spaced apart from the outermost perimeter of the border region.

34. The touch sensitive projection screen of claim 11, wherein each of the first and second openings is spaced apart from the innermost perimeter of the border region.

35. The touch sensitive projection screen of claim 11, wherein the first opening is adjacent the second opening.

36. The touch sensitive projection screen of claim 11 further comprising:
a first flexible printed circuit disposed in the first opening and making electrical contact with the first conductive traces in the first terminal area, the first flexible printed circuit adhering to the corresponding portion of the first support layer exposed in the first opening; and
a second flexible printed circuit disposed in the second opening and making electrical contact with the second conductive traces in the second terminal area, the second flexible printed circuit adhering to the corresponding portion of the second support layer exposed in the second opening.

37. The touch sensitive projection screen of claim 11 being substantially flexible.

38. A touch sensitive projection screen adapted for use on a horizontal surface and having a touch sensitive display region surrounded by a border region, the projection screen comprising:
a touch sensitive film comprising:
a plurality of spaced apart opaque drive electrodes disposed along a first direction in the touch sensitive display region, and a plurality of first conductive traces disposed in the border region and routing the drive electrodes to a first terminal area in the border region, the drive electrodes and the first conductive traces and the first terminal area formed on a first shrinkable support layer;
a plurality of spaced apart opaque sense electrodes disposed along a second direction, perpendicular to the first direction, in the touch sensitive display region, and a plurality of second conductive traces disposed in the border region and routing the sense electrodes to a second terminal area in the border region, the sense electrodes and the second conductive traces and the second terminal area formed on a second shrinkable support layer;
a first optical diffuser shrinkable layer disposed on the touch sensitive film and comprising a plurality of particles dispersed therein; and
a second optical diffuser shrinkable layer disposed on and spaced apart from the first optical diffuser layer and comprising a plurality of particles dispersed therein, each of the first and second optical diffuser layers diffusely reflecting at least 90% of light incident on the diffuser layer; wherein
the first and second shrinkable support layers and the first and second optical diffuser shrinkable layers are preshrunk at a temperature greater than a highest operating temperature of the projection screen.

39. The touch sensitive projection screen of claim 38, further comprising a third optical diffuser layer disposed on the second optical diffuser shrinkable layer and having a structured surface facing away from the second optical diffuser layer.

40. The touch sensitive projection screen of claim 38, further comprising an anti-slip film adapted to prevent the projection screen from sliding when the projection screen is placed on a horizontal surface.

41. The touch sensitive projection screen of claim 40, further comprising a first layer adhered to the anti-slip film via an adhesive and a second layer adhered to the first layer via an adhesive, the first and second layers preventing the projection screen from curling.

42. The touch sensitive projection screen of claim 38, wherein the first and second shrinkable support layers comprise PET.

43. The touch sensitive projection screen of claim 38, wherein the first and second optical diffuser shrinkable layers comprise PET.

44. The touch sensitive projection screen of claim 38, wherein the first and second shrinkable support layers and the first and second optical diffuser shrinkable layers comprise PET.

45. A touch sensitive system having a touch sensitive region surrounded by a border region, the touch sensitive system comprising:
a plurality of spaced apart drive electrodes disposed along a first direction in the touch sensitive region, and a plurality of first conductive opaque traces disposed in the border region and routing the drive electrodes to a first terminal area in the border region, the drive electrodes and the first conductive opaque traces and the first terminal area formed on a first support layer more shrinkable along a first in-plane direction than along an orthogonal second in-plane direction;
a plurality of spaced apart sense electrodes disposed along a second direction, orthogonal to the first direction, in the touch sensitive region, and a plurality of second conductive opaque traces disposed in the border region and routing the drive electrodes to a second terminal area in the border region, the sense electrodes and the second conductive opaque traces and the second terminal area formed on a second support layer more shrinkable along the second in-plane direction than along the first in-plane direction; and
a plurality of nodes, each node defined by corresponding drive and sense electrodes traversing each other at the node, the touch sensitive system configured to detect a location of a touch applied proximate a node by detecting a change in a coupling capacitance between the corresponding drive and sense electrodes traversing each other at the node.

46. The touch sensitive system of claim 45, wherein the first support layer and the second support layer comprise PET.

47. The touch sensitive system of claim 45, wherein the first support layer and the second support layer are preshrunk at a temperature greater than a highest operating temperature of the touch sensitive system.

48. The touch sensitive system of claim 45, further comprising an anti-slip film adapted to prevent the touch sensitive system from sliding when the touch sensitive system is placed on a horizontal surface.
